(19) United States
(12) Patent Application Publication
(10) Pub. No.: US 2008/0233039 A1
(43) Pub. Date: Sep. 25, 2008

(54) Catalysts For Co Oxidation,Voc Combustion And Nox Reduction And Methods Of Making And Using The Same

(75) Inventors: Alfred Hagemeyer, Rheine (DE); Anthony F. Volpe, Sunnyvale, CA (US); Valery Sokolovskii, Sunnyvale, CA (US); Andreas Lesik, Neckarsulm (DE); Guido Streukens, Velbert (DE)

Correspondence Address: DERICK E. ALLEN (28217);ARMSTRONG TEASDALE LLP, ONE METROPOLITAN SQUARE, SUITE 2600, ST. LOUIS, MO, 63102-2740, US

(73) Assignee: SYMYX TECHNOLOGIES, INC., Sunnyvale, CA (US)

(21) Appl. No.: 11/916,399

(22) PCT Filed: Jun. 1, 2006
(86) PCT No.: PCT/US2006/021571

§ 371 Date: Apr. 30, 2008

Related U.S. Application Data
(60) Provisional application No. 60/687,007, filed on Jun. 2, 2005.

(51) Int. Cl. C01B 21/00; B01J 23/10; B01J 23/26; B01J 23/75; B01J 23/83; B01J 23/86; C01B 31/20

(52) U.S. Cl. 423/351; 423/437.2; 423/437.1; 502/326; 502/327; 502/304; 502/303; 502/242; 502/246; 502/251; 502/252; 502/260; 502/65; 502/66; 502/64; 502/73; 502/74; 502/308; 502/309; 502/311; 502/313

(57) ABSTRACT

The present invention is directed to carbon monoxide oxidation reactions in the presence of an O₂ containing gas, nitrogen oxide conversion reactions, volatile organic compound conversion reactions in the presence of an O₂ containing gas, and combinations thereof, and catalysts for use in those reactions. The catalyst comprises cobalt, its oxides or mixtures thereof and ruthenium, its oxides or mixtures thereof.

### FIELD OF THE INVENTION

The invention relates to methods and catalysts for oxidizing carbon monoxide and volatile organic compounds in the presence of O₂, as well as reducing NOₓ species from gas mixtures containing carbon monoxide, volatile organic compounds and/or NOₓ, such as engine exhaust mixtures. More particularly, the invention includes methods using catalysts which contain ruthenium and cobalt. The catalysts may be supported on a variety of catalyst support materials. The ruthenium-cobalt catalysts of the invention exhibit both high activity and selectivity to carbon monoxide oxidation to carbon dioxide.

### BACKGROUND OF INVENTION

The catalytic oxidation of carbon monoxide to carbon dioxide is a key process for many different systems, including the stabilization of CO₂-lasers, respiratory protection, industrial air purification, automotive emissions control, CO clean up in flue gases and fuel cells, rescue equipment and space and deep sea technology.

Extensive research has been conducted to improve CO oxidation catalytic activity at low temperatures. For example, a large amount of the emissions from automobiles is released during the first minutes after a “cold start,” before the catalyst becomes hot enough to convert the harmful emissions. Also, new and fuel-efficient engines generate colder exhaust gases than current engines, resulting in slower heating of the catalyst. This places new demands on the low temperature activity for the catalytic converters used in future emission abatement systems.

Supported noble metals such as Pt or Pd have been found to be efficient catalysts for low-temperature CO oxidation, but Pt and Pd are expensive. Other systems, such as those including Au, Rh, Ag, and Cu, supported on carriers or dispersed in perovskites have also been investigated. Some well known commercial catalysts for room temperature CO oxidation are based on Au catalysts, CuMnO₄ (hopcalite) and CuCoAgMnOₓ mixed oxides, which show high activity. However, these systems are not very moisture resistant. They rapidly deactivate in the presence of water and are not long-lived in the atmosphere.

Nitrogen oxides are air pollutants emitted by boilers, furnaces, engines, incinerators, and other combustion sources. Nitrogen oxides include nitric oxide (NO), nitrogen dioxide (NO₂), and nitrous oxide (N₂O). Total NO+NO₂ is usually referred to as NOₓ. Combustion sources produce nitrogen oxides mainly in the form of NO. Some NO₂ and N₂O are also formed, but their concentrations are typically less than 5% of the NO concentration, which is generally in the range of about 200-1000 ppm. Nitrogen oxides are the subject of growing concern because they are toxic compounds, and are precursors to acid rain and photochemical smog. Nitrous oxide also contributes to the greenhouse effect.

Combustion modifications such as low NOₓ burners (LNB) and overfire air (OFA) injection provide only modest NOₓ control, reducing NOₓ concentrations by about 30-50%. However, their capital costs are low and, since no reagents are required, their operating costs are near zero. For deeper NOₓ control, Selective Catalytic Reduction (SCR), reburning, Advanced Reburning (AR), or Selective Non-Catalytic Reduction (SNCR) can be used in conjunction with low NOₓ burners and overfire air injection, or they can be installed as stand-alone systems.

Contamination of the environment by volatile organic compounds (VOCs) is also of great concern. VOCs, which include compounds such as alcohols, aldehydes, aromatics, ketones, acetates, alkanes and chlorinated hydrocarbons, originate in many ways, including spray painting and engine maintenance (degreasing and fuel system repair), indoor air decontamination, dry cleaning, food processing (grills and deep fryers), fume hoods, residential use and solvent-intensive industrial processes. VOCs have direct and secondary (e.g. photochemical smog) effects on health and the environment.

Direct methods for removing VOCs from contaminated air require heating the air stream to relatively high temperatures to incinerate the contaminants. The cost required to maintain such elevated temperatures (around 815 to 925° C.) and to cool the surroundings can be unacceptably high. For the removal of volatile organic compounds (VOCs), various techniques have been proposed. One of them is the heterogeneous catalytic oxidation to carbon dioxide and water. This method is an advantage over the more common thermal oxidation process, since it requires little or no supplementary fuel and is therefore a less expensive process.

The catalytic oxidation of VOCs has been widely studied, and many factors affect the effectiveness of the combustion, such as the nature of the catalyst, the type of the VOCs, reaction temperature, space velocity and catalyst deactivation.

Many different catalytic systems have been studied for VOC combustion. Supported noble metals are the most commonly used catalysts, and account for approximately 75% of all industrial VOC removal applications. Noble metals show high activity at relatively low temperatures and high selectivity for the formation of CO₂ and water with minimal partial oxidation products.

The most common support for noble metal VOC removal catalysts is alumina, although this support is often the cause for deactivation of the catalyst by halogen species, the formed aluminum halides block the active species. Therefore, much research has been made into the development of alternative supports for combustion catalysts.

The use of automobile exhaust gas catalysts has contributed to a significant improvement in air quality. The most commonly used catalyst is the “three-way catalyst” (TWC) which has three main duties, namely, the oxidation of CO, the oxidation of VOCs and the reduction of NOₓ to N₂. Such catalysts require careful engine management techniques to ensure that the engine operates at or close to stoichiometric conditions. For technical reasons, however, it is necessary for engines to operate at various stages during an operating cycle. When the engine is running rich, for example during acceleration, the overall exhaust gas composition is reducing in nature, and it is more difficult to carry out oxidation reactions on the catalyst surface. For this reason, TWC's have been developed to incorporate a component which stores oxygen during leaner periods of the operating cycle, and releases oxygen during richer periods of the operating cycle, thus extending the effective operating envelope. This component is believed to be ceria-based in the vast majority of current commercial TWC's. Ceria, however, especially when doped with precious metal catalysts such as Pd, shows a great tendency to lose surface area when exposed to high temperatures, eg 800° C. or above, and the overall performance of the catalyst is degraded. Because of this, TWC's are being proposed and introduced in some demanding markets which use, instead of ceria as the oxygen storage component, ceria-zirconia mixed oxides, which are much more stable to loss of surface area than ceria alone. Ceria itself is a rare earth metal with restricted suppliers and ceria-zirconia is a relatively expensive material when available commercially, and it would be desirable to find a material having at least as good oxygen storage performance as ceria-zirconia, but utilizing less expensive materials.

Thus what is needed is a CO oxidation catalyst that has high activity in the presence of O₂, is cheaper than current noble metal systems and can operate in the presence of moisture.

What is also needed is an effective NOₓ reduction catalyst.

What is also needed is an effective VOC oxidation catalyst.

Finally, what is also needed is a catalyst system that can perform all three of the above reactions, for example, as a TWC.

### SUMMARY OF INVENTION

In one embodiment, the present invention provides new catalysts for the oxidation of CO to CO₂.

In another embodiment, the present invention provides new catalysts for the combustion of VOCs.

In another embodiment, the present invention provides new catalysts for the reduction of NOₓ to N₂.

In one embodiment, the invention is a method for oxidizing carbon monoxide. The method includes contacting a carbon monoxide containing gas with a catalyst composition in the presence of an O₂ containing gas. The catalyst comprises: a) cobalt, its oxides or mixtures thereof; and b) ruthenium, its oxides or mixtures thereof.

In another embodiment, the invention provides a method for converting nitrogen oxides. The method includes contacting a nitrogen oxide containing gas with a catalyst comprising cobalt, its oxides or mixtures thereof and ruthenium, its oxides or mixtures thereof.

In another embodiment, the invention provides a method for converting volatile organic compounds. The method includes contacting a volatile organic compound containing gas with a catalyst in the presence of an O₂ containing gas. The catalyst comprises: a) cobalt, its oxides or mixtures thereof; and b) ruthenium, its oxides or mixtures thereof.

In another embodiment, the invention provides new catalyst compositions comprising cobalt and/or cerium, their oxides and mixtures thereof and methods of making those compositions. Catalyst compositions of the invention preferably comprise ruthenium and cobalt.

Briefly, therefore, the present invention is directed to catalyst compositions and reaction methods that utilize those compositions.

The catalyst compositions of the invention may be used to reduce the concentration of VOCs in a gaseous atmosphere. Preferably, the VOCs are converted to carbon dioxide and water. Preferably, the gaseous atmosphere is oxygen-containing, and most preferably, the gaseous atmosphere is air. Catalyst composition of the invention may be used to reduce the concentration of VOCs in gases containing any concentration of VOCs. In one application, catalyst compositions of the invention may reduce the concentration of VOCs in air where there is an excess of oxygen and between between 10 ppm and percent levels of VOCs.

The catalysts of the invention are useful to reduce the concentration of VOCs in gases at low temperatures (from about 200° C. and below). Specifically, temperatures from about 150° C. to about 30° C. are used. Most specifically, temperatures of about 100° C. and below are used

Other features, objects and advantages of the present invention will be in part apparent to those skilled in art and in part pointed out hereinafter. All references cited in the instant specification are incorporated by reference for all purposes. Moreover, as the patent and non-patent literature relating to the subject matter disclosed and/or claimed herein is substantial, many relevant references are available to a skilled artisan that will provide further instruction with respect to such subject matter.

### DETAILED DESCRIPTION OF THE INVENTION

The invention relates to a method for converting carbon monoxide, nitrogen oxides and/or volatile organic compounds, such as those found in engine exhaust. According to one aspect, the method includes contacting a CO-containing gas, a VOC-containing gas, and/or a nitrogen oxide-containing gas with a catalyst in the presence of O₂. According one aspect, the method includes simultaneously contacting a CO, NOₓ and VOC-containing gas with a catalyst in the presence of O₂ to produce carbon dioxide and nitrogen. The invention also relates to a catalyst itself and to apparatus such as a TWC comprising such catalysts.

In one embodiment, a catalyst according to the invention comprises:

Ru, its oxides or mixtures thereof;

Co, its oxides or mixtures thereof; and optionally

at least one of a main group metal (i.e., Al, Ga, In, Tl, Sn, Pb, or Bi), a transition metal, or a rare earth metal (i.e., lanthanides), their oxides and mixtures thereof, more specifically, Ce, Y, Sn, Zr, Ti, Ag, Pt, Cu, Mn, Cr, Nb, Ni, Re, Fe, Pr, Sm, Nd, Yb, Eu, their oxides and mixtures thereof, and more specifically Ce, Y, Sn, Zr, Ti, Ag, Pt, Cu, Mn, Cr, Nb, Ni, Re, Fe, their oxides and mixtures thereof. The catalyst may be supported on a carrier, such as any one member or a combination of silica, alumina, zirconia, titania, ceria, magnesia, lanthania, niobia, zeolite, perovskite, silica clay, yttria and iron oxide and carbon.

The catalysts of the invention comprise combinations of Ru and Co and metals or metalloids, selected from Ce, Y, Sn, Zr, Ti, Ag, Cu, Mn, Ni, Re, Fe, and noble metals, such as Pt, in each and every possible permutation and combination.

Discussion regarding the particular function of various components of catalysts and catalyst systems is provided herein solely to explain the advantage of the invention, and is not limiting as to the scope of the invention or the intended use, function, or mechanism of the various components and/or compositions disclosed and claimed. As such, any discussion of component and/or compositional function is made, without being bound by theory and by current understanding, unless and except such requirements are expressly recited in the claims. Generally, for example, and without being bound by theory, ruthenium metal has activity as a CO oxidation, VOC oxidation and NOₓ reduction catalyst. Co, and the group of metals comprised of Ce, Y and noble metals may themselves have activity as catalysts for these reactions, but function in combination with Ru to impart beneficial properties to the catalyst of the invention. In particular, Ru—Co and Ru—Co—Ce have been identified as very synergistic compositions.

In one embodiment, catalysts of the invention can catalyze CO and VOC oxidations and NOx reduction reactions at varying temperatures. The composition of the catalysts of the invention and their use in these reactions are discussed below.

### 1. Definitions

CO oxidation reaction: Reaction which produces carbon dioxide from O₂ and carbon monoxide, and vice versa:

½O₂+CO→CO₂

Generally, and unless explicitly stated to the contrary, each of the catalysts of the invention can be advantageously applied in connection with the reaction as shown above.

NOₓ reaction: Reaction which produces nitrogen gas and water from a nitrogen oxide. In the case of SCR (Selective Catalytic Reduction)-DeNOx using NH3 as reductant, the possible chemical reactions are given below:

4NO+4NH3+O2→4N2+6H2O (1) standard SCR

6NO+4NH3→5N2+6H2O (2)

2NO2+4NH3+O2→+3N2+6H2O (3)

6NO2+8NH3→7N2+12H2O (4)

NO+NO2+2NH3→2N2+3H2O (5) fast SCR

Other reductants such as hydrocarbons are also possible. The direct decomposition of NOₓ into N₂ and O₂ is another pathway for DeNOₓ.

Volatile Organic Compound (VOC): Compound containing compounds such as alcohols, aldehydes, aromatics, ketones, acetates, alkanes and chlorinated hydrocarbons.

The Periodic Table of the Elements is based on the present IUPAC convention, thus, for example, Group 9 comprises Co, Rh and Ir. (See http://www.iupac.org dated May 30, 2002).

As discussed herein, the catalyst composition nomenclature uses a dash (i.e., “—”) to separate catalyst component groups where a catalyst may contain one or more of the catalyst components listed for each component group, brackets (i.e., “{ }”) are used to enclose the members of a catalyst component group, “{two of . . . }” is used if two or more members of a catalyst component group are required to be present in a catalyst composition, “blank” is used within the “{ }” to indicate the possible choice that no additional element is added, and a slash (i.e., “/”) is used to separate supported catalyst components from their support material, if any. Additionally, the elements within a catalyst composition formulation include all possible oxidation states, including oxides, or salts, or mixtures thereof.

Using this shorthand nomenclature in this specification, for example, “P—{Ph, Ni}—{Na, K, Fe, Os}/ZrO₂” would represent catalyst compositions containing Pt, one or more of Rh and Ni, and one or more of Na, K, Fe, and Os supported on ZrO₂; all of the catalyst elements may be in any possible oxidation state, unless explicitly indicated otherwise. “Pt—Rh—Ni—{two of Na, K, Fe, Os}” would represent a supported or unsupported catalyst composition containing Pt, Rh, and Ni, and two or more of Na, K, Fe, and Os. “Rh—{Cu,Ag,Au}—{Na, K, blank}/TiO₂” would represent catalyst compositions containing Rh, one or more of Cu, Ag and Au, and, optionally, and one of Na or K supported on TiO₂.

The description of a catalyst composition formulation as having an essential absence of an element, or being “element-free” or “substantially element free” does allow for the presence of an insignificant, non-functional amount of the specified element to be present, for example, as a non-functional impurity in a catalyst composition formulation. However, such a description excludes formulations where the specific element has been intentionally or purposefully added to the formulation to achieve a certain measurable benefit. Typically, with respect to noble metals such as Pt for example, amounts less than about 0.01 weight percentage would not usually impart a material functional benefit with respect to catalyst performance, and therefore such amounts would generally be considered as an insignificant amount, or not more than a mere impurity. In some embodiments, however, amounts up to less than about 0.04 weight percent may be included without a material functional benefit to catalyst performance. In other embodiments, amounts less than about 0.005 weight percent would be considered an insignificant amount, and therefore a non-functional impurity.

### Catalyst

In one embodiment, a catalyst of the invention comprises:

Ru, its oxides or mixtures thereof;

Co, its oxides or mixtures thereof; and optionally

at least one of a main group metal (i.e., Al, Ga, In, Tl, Sn, Pb, or Bi), a transition metal, or a rare earth metal (i.e., lanthanides), their oxides and mixtures thereof, more specifically, Ce, Y, Sn, Zr, Ti, Ag, Pt, Cu, Mn, Cr, Nb, Ni, Re, Fe, Pr, Sm, Nd, Yb, Eu, their oxides and mixtures thereof, and more specifically Ce, Y, Sn, Zr, Ti, Ag, Pt, Cu, Mn, Cr, Nb, Ni, Re, Fe, their oxides and mixtures thereof.

In one embodiment, the catalyst comprises Ru, Co and Ce. In another embodiment, the catalyst comprises Co, Ru and Y, and in another embodiment, the catalyst comprises Co, Ru, Ce and Y. The catalyst components are typically present in a mixture of the reduced or oxide forms; typically one of the forms will predominate in the mixture. The catalysts of the invention may be supported on carriers. Suitable carriers for supported catalysts are discussed below.

A catalyst of the invention may be prepared by mixing the metals and/or metalloids in their elemental forms or as oxides or salts to form a catalyst precursor. This catalyst precursor mixture generally undergoes a calcination and/or reductive treatment, which may be in situ (within the reactor), prior to use as a catalyst. Without being bound by theory, the catalytically active species are generally understood to be species which are in the reduced elemental state or in other possible higher oxidation states. The catalyst precursor species are believed to be substantially completely converted to the catalytically active species by the pre-use treatment. Nonetheless, the catalyst component species present after calcination and/or reduction may be a mixture of catalytically active species such as the reduced metal or other possible higher oxidation states and uncalcined or unreduced species depending on the efficiency of the calcination and/or reduction conditions.

### A. Catalyst Compositions

As discussed above, one embodiment of the invention is a catalyst for catalyzing a CO oxidation. According to the invention, a CO oxidation catalyst may have the following composition:

Ru, its oxides or mixtures thereof;

Co, its oxides or mixtures thereof; and optionally

at least one of a main group metal (i.e., Al, Ga, In, Tl, Sn, Pb, or Bi), a transition metal, or a rare earth metal (i.e., lanthanides), their oxides and mixtures thereof, more specifically, Ce, Y, Sn, Zr, Ti, Ag, Pt, Cu, Mn, Cr, Nb, Ni, Re, Fe, Pr, Sm, Nd, Yb, Eu, their oxides and mixtures thereof, and more specifically Ce, Y, Sn, Zr, Ti, Ag, Pt, Cu, Mn, Cr, Nb, Ni, Re, Fe, their oxides and mixtures thereof.

The amount of each component present in a given catalyst according to the present invention may vary depending on the reaction conditions under which the catalyst is intended to operate. Generally, the ruthenium component may be present as either a bulk catalyst or a supported catalyst and may be present in an amount ranging from about 0.01 wt. % to about 10 wt. %, preferably about 0.01 wt. % to about 5 wt. %, and more preferably about 1 wt. % to about 5 wt. %.

Cobalt may be present as either a bulk catalyst or a supported catalyst composition. Bulk cobalt catalysts may have Co concentration ranging from a high of about 60% to a low of about 1%, preferred is about 45% to about 5%; generally a bulk cobalt catalyst may contain about 10 wt. % binder. Bulk cobalt catalysts may also contain other components such as zirconium, magnesium, silicon or aluminum. Supported cobalt catalysts may have Co concentrations ranging from about 0.05% up to about 25 wt. % Co, with about 0.10% to about 15% a preferred range for Co concentration.

Other components, such as Ce, Y, Sn, Zr, Ti, Ag, Pt, Cu, Mn, Cr, Nb, Ni, Re, Fe, and their oxides may be present, typically, in amounts ranging from about 0 wt. % to about 60 wt. %, preferably from about 10 wt. % to about 50 wt. %. Pt may be present typically, in an amount ranging from about 0 wt. % to about 2 wt. %, preferably from about 0.05 wt. % to about 1 wt. %.

The above weight percentages are calculated on the total weight of the catalyst component, in its final state in the catalyst composition after the final catalyst preparation step (i.e., the resulting oxidation state or states) with respect to the total weight of all catalyst components plus the support material, if any. The presence of a given catalyst component in the support material and the extent and type of its interaction with other catalyst components may effect the amount of a component needed to achieve the desired performance effect.

In a preferred embodiment, the catalyst of the invention comprises Ru, Co and at least one of Ce, Pt and Y.

In another preferred embodiment, the catalyst comprises Ru, Co, Ce and at least one of Pt and Y. In a preferred embodiment, the catalyst comprises Ru, Co, Pt and at least one of Ce and Y. In another particularly preferred embodiment, the platinum-free catalyst comprises Ru, Co, Ce and Y.

### Catalyst Components a) and b): Ru and Co

In some embodiments, Ru, its oxides or mixtures thereof and Co, its oxides or mixtures thereof are metal components in catalyst compositions for the reactions of the invention. Ru and Co may be present in an independent combination of their reduced forms and their oxides.

Catalyst Component c): Components other than Ru and Co

The catalysts of the invention may contain at least three metals or metalloids. In some embodiments, in addition to the Ru and Co components discussed above, the catalyst may contain metals or metalloids which, when used in combination with Ru and Co, function to impart beneficial properties to the catalyst of the invention. A catalyst of the invention, then, further comprises at least one of a main group metal (i.e., Al, Ga, In, Tl, Sn, Pb, or Bi), a transition metal, or a rare earth metal (i.e., lanthanides), their oxides and mixtures thereof, more specifically, Ce, Y, Sn, Zr, Ti, Ag, Pt, Cu, Mn, Cr, Nb, Ni, Re, Fe, Pr, Sm, Nd, Yb, Eu, their oxides and mixtures thereof, and more specifically Ce, Y, Sn, Zr, Ti, Ag, Pt, Cu, Mn, Cr, Nb, Ni, Re, Fe, their oxides and mixtures thereof.

There are several metals which may be incorporated into a catalyst according to the invention. Hence, the various elements recited as components in any of the described embodiments may be included in any various combination and permutation to achieve a catalyst composition that is coarsely or finely tuned for a specific application (e.g., including for a specific set of conditions, such as, temperature, pressure, space velocity, catalyst precursor, catalyst loading, catalyst surface area /presentation, reactant flow rates, reactant ratios, etc.). In some cases, the effect of a given component may vary with the operating temperature for the catalyst. These catalyst components may function as, for instance, activators or moderators depending upon their effect on the performance characteristics of the catalyst. For example, if greater activity is desired, an activator may be incorporated into a catalyst, or a moderator may be replaced by at least one activator or, alternatively, by at least one moderator one step further up the “activity ladder.” An “activity ladder” ranks secondary or added catalyst components, such as activators or moderators, in order of the magnitude of their respective effect on the performance of a principal catalyst constituent. Conversely, if selectivity of a catalyst needs to be increased, then either an activator may be removed from the catalyst or, alternatively, the current moderator may be replaced by at least one moderator one step down the “activity ladder.” The function of these catalyst components may be further described as “hard” or “soft” depending on the relative effect obtained by incorporating a given component into a catalyst. The catalyst components may be metals, metalloids, or non-metals.

### Supports

The support or carrier may be any support or carrier used with the catalyst which allows the CO oxidation, VOC combustion and/or NOₓ reduction reaction to proceed. The support or carrier may be a porous, adsorptive, high surface area support with a surface area of about 25 to about 1500 m²/g. The porous carrier material may be relatively inert to the conditions utilized in the process, and may include carrier materials such as, (1) activated carbon, carbon black, coke, or charcoal; (2) silica or silica gel, silicon carbide, silicon nitride, clays, and silicates including those synthetically prepared and naturally occurring, for example, china clay, diatomaceous earth, fuller's earth, kaolin, bentonite etc.; (3) ceramics, porcelain, bauxite; (4) refractory inorganic oxides such as alumina, titanium dioxide, zirconium oxide, magnesia, ceria, spinels, etc.; (5) crystalline and amorphous aluminosilicates such as naturally occurring or synthetically prepared mordenite and/or faujasite; and, (6) transition metal oxides and (7) rare earth metal oxides and (8) combinations of these groups.

When a catalyst of the invention is a supported catalyst, the support utilized may contain one or more of the metals (or metalloids) of the catalyst. The support may contain sufficient or excess amounts of the metal for the catalyst such that the catalyst may be formed by combining the other components with the support. Examples of such supports include cobalt oxide, which can contribute cobalt, Co, ceria which can contribute cerium, Ce, to a catalyst or iron oxide which can contribute iron, Fe. When such supports are used, the amount of the catalyst component in the support may be far in excess of the amount of the catalyst component needed for the catalyst. Thus the support may act as both an active catalyst component and a support material for the catalyst. Alternatively, the support may have only minor amounts of a metal making up the catalyst such that the catalyst may be formed by combining all desired components on the support.

Catalysts may also be supported on a carrier comprising alumina, zirconia, titania, ceria, magnesia, lanthania, niobia, zeolite, perovskite, silica clay, yttria, cobalt oxide, tin oxide, iron oxide and mixed metal oxides, such as CeSnCo and carbon. Perovskite as well as supported perovskites (e.g., supported on any of the previously listed carriers) may also be utilized as a support for the catalyst formulations. In one embodiment, the support is selected from the group consisting of cobalt oxide, ceria and zirconia.

High surface area aluminas, such as gamma-, delta- or theta-alumina, mixed silica alumina, sol-gel alumina, and sol-gel or coprecipitated alumina-zirconia carriers may be used. Alumina typically has a higher surface area and a higher pore volume than carriers such as zirconia and may offers a price advantage over other more expensive carriers.

Examples of a carrier supported catalyst of the invention include: Ru—Co—{Zr, Pt}/SiO₂, particularly Ru—Co—Pt/SiO₂; and

Ru—Co—{Pt, blank}/CeO₂; particularly Ru—Co—Pt/ CeO₂; and Ru—Co/CeO₂.

### Methods of Making a Catalyst

As set forth above, a catalyst of the invention may be prepared by mixing the metals and/or metalloids in their elemental forms or as oxides or salts to form a catalyst precursor, which generally undergoes a calcination and/or reductive treatment. Without being bound by theory, the catalytically active species are generally understood to be species which are in the reduced elemental state or in other possible higher oxidation states.

The catalysts of the invention may be prepared by any well known catalyst synthesis processes. See, for example, U.S. Pat. Nos. 6,299,995 and 6,293,979 and U.S. Patent Application No. 60/677,137, entitled “Methods Of Making High Surface Area Metal And Metal Oxide Materials” filed on May 2, 2005. Spray drying, precipitation, impregnation, incipient wetness, ion exchange, fluid bed coating, physical or chemical vapor deposition are just examples of several methods that may be utilized to make the present catalysts. Preferred approaches include, for instance, impregnation or incipient wetness. The catalyst may be in any suitable form, such as, pellets, granular, powder, in a fixed or fluidized bed, or monolith.

The catalyst of the invention may be prepared on a solid support or carrier material. Preferably, the support or carrier is, or is coated with, a high surface area material onto which the precursors of the catalyst are added by any of several different possible techniques, as set forth above and as known in the art. The catalyst of the invention may be employed in the form of pellets, or on a support, preferably a monolith, for instance a honeycomb monolith.

Catalyst precursor solutions are preferably composed of easily decomposable forms of the catalyst component in a sufficiently high enough concentration to permit convenient preparation. Examples of easily decomposable precursor forms include the nitrate, acetate, amine, and oxalate salts. Typically, chlorine containing precursors are avoided to prevent chlorine poisoning of the catalyst. Solutions can be aqueous or non-aqueous solutions. Exemplary non-aqueous solvents can include polar solvents, aprotic solvents, alcohols, and crown ethers, for example, tetrahydrofuran and ethanol. Concentration of the precursor solutions generally may be up to the solubility limitations of the preparation technique with consideration given to such parameters as, for example, porosity of the support, number of impregnation steps, pH of the precursor solutions, and so forth. The appropriate catalyst component precursor concentration can be readily determined by one of ordinary skill in the art of catalyst preparation.

Ti—Titanium precursors which may be utilized in the present invention include, but are not limited to, ammonium titanyl oxalate, (NH₄)₂TiO(C₂O₄)₂, available from Aldrich, and titanium(IV) bis(ammonium lactato)dihydroxide, 50 wt. % solution in water, [CH₃CH(O—)CO₂NH₄]₂Ti(OH)₂, available from Aldrich. Other titanium containing precursors include Ti oxalate prepared by dissolving a Ti(IV) alkoxide, such as Ti(IV) propoxide, Ti(OCH₂CH₂CH₃)₄, (Aldrich) in 1M aqueous oxalic acid at 60° C. and stirring for a couple of hours, to produce a 0.72M clear colorless solution; TiO(acac)oxalate prepared by dissolving Ti(IV) oxide acetylacetonate, TiO(acac)₂, (Aldrich) in 1.5M aqueous oxalic acid at 60° C. with stirring for a couple of hours, following by cooling to room temperature overnight to produce 1M clear yellow-brown solution; TiO(acac)₂, may also be dissolved in dilute acetic acid (50:50 HOAc:H₂O) at room temperature to produce a 1M clear yellow solution of TiO-acac. Preferably, titanium dioxide in the anatase form is utilized as a catalyst precursor material.

Fe—Iron (III) nitrate, Fe(NO₃)₃, iron(III) ammonium oxalate, (NH₄)₃ Fe(C₂O₄)₃, iron(III) oxalate, Fe₂(C₂O₄)₃, and iron(II) acetate, Fe(OAc)₂, are all water soluble; although the iron(III)oxalate undergoes thermal decomposition at only 100° C. Potassium iron(III) oxalate, iron(III) formate and iron(III) citrate are additional iron precursors.

Co—Both cobalt nitrate and acetate are water soluble precursor solutions. The cobalt (II) formate, Co(OOCH)₂, has low solubility in cold water of about 5 g/100mL, while cobalt (II) oxalate is soluble in aqueous NH₄Ob 0H. Another possible precursor is sodium hexanitrocobaltate(III), Na₃Co(NO₂)₆ which is water soluble, with gradual decomposition of aqueous solutions slowed by addition of small amounts of acetic acid. Hexaammine Co(III) nitrate is also soluble in hot (65° C.) water and NMe₄OH. Cobalt citrate, prepared by dissolving Co(OH)₂ in aqueous citric acid at 80° C. for 1 to 2 hours, is another suitable cobalt precursor.

Y—Yttrium nitrate and acetate are both possible catalyst precursors.

Zr—Zirconyl nitrate and acetate, commercially available from Aldrich, and ammonium Zr carbonate and zirconia, available from MEI, are possible precursors for zirconium in either or both the support or catalyst formulation itself.

Ru—Ru nitrosyl nitrate, Ru(NO)(NO₃)₃ (Aldrich), potassium ruthenium oxide, K₂RuO₄.H₂O, potassium perruthenate, KRuO₄, ruthenium nitrosyl acetate, Ru(NO)(OAc)₃, and tetrabutylammonium perruthenate, NBu₄RuO₄, are all possible ruthenium metal catalyst precursors. NMe₄Ru(NO)(OH)₄ solution can be prepared by dissolving Ru(NO)(OH)₃ (0.1 M) (H. C. Starck) in NMe₄OH (0.12M) at 80° C. produces a clear dark red-brown 0.1M Ru solution useful as a catalyst precursor solution.

Ag—Silver nitrate, silver nitrite, silver diammine nitrite, and silver acetate are possible silver catalyst precursors.

Sn—Tin oxalate produced by reacting the acetate with oxalic acid may be used as a catalyst precursor. Tin tartrate, SnC₄H₄O₆, in NMe₄OH at about 0.25M Sn concentration, and tin acetate, also dissolved in NMe₄OH at about 0.25M Sn concentration, may be used as catalyst precursors as well as tin acetate or tin acac dissolved in aqueous organic acids or alcohols such as ethanol or ketones such as acac.

Ce—Ce(III) and Ce(IV) solutions may be prepared from Ce(III) nitrate hexahydrate, Ce(NO₃)₃.6H₂O, (Aldrich) and ammonium cerium(IV) nitrate, (NH₄)₂Ce(NO₃)₆, (Aldrich), respectively, by dissolution in room temperature water. Nitric acid, 5 vol. %, may be added to the Ce(III) salt to increase solubility and stability. Ce(OAc)₃ (Alfa) or Ce(NO₃)(Alfa) may also be utilized as a catalyst precursor.

Pt—Platinum catalyst compositions may be prepared by using any one of a number of precursor solutions, such as, Pt(NH₃)₄(NO₃)₂ (Aldrich, Alfa, Heraeus, or Strem), Pt(NH₃)₂(NO₂)₂ in nitric acid, Pt(NH₃)₄(OH)₂ (Alfa), K₂Pt(NO₂)₄, Pt(NO₃)₂, PtCl₄ and H₂PtCl₆ (chloroplatinic acid). Pt(NH₃)₄(HCO₃)₂, Pt(NH₃)₄(HPO₄), (NMe₄)₂Pt(OH)₆, H₂Pt(OH)₆, K₂Pt(OH)₆, Na₂Pt(OH)₆ and K₂Pt(CN)₆ are also possible choices along with Pt oxalate salts, such as K₂Pt(C₂O₄)₂. The Pt oxalate salts may be prepared from Pt(NH₃)₄(OH)₂ which is reacted with 1M oxalic acid solution to produce a clear, colorless solution of the desired Pt oxalate salts.

The invention also relates to a method for producing a N₂ and/or CO₂ gas, from CO, a VOC or a nitrogen oxide. In one embodiment, the invention is a method for oxidizing CO in the presence of O₂ and a catalyst described herein. In another embodiment the invention is a method for combustion of a VOC in the presence of O₂ and a catalyst described herein. In another embodiment, the invention is a method for reducing NOₓ in the presence of NH₃ or urea, and optionally O₂ and a catalyst described herein.

In one embodiment, a CO-containing gas, a VOC containing gas, and/or a NOₓ containing gas contacts a catalyst in the presence of O₂ according to the method of the invention. The reaction preferably may occur at a temperature of less than 200° C. to produce CO₂ and/or N₂. The ratio of O₂ to CO is preferably 1:1 to 100:1, and more preferably 5:1 to 50:1.

A method of the invention may be utilized over a broad range of reaction conditions. Specifically, the method is conducted at a pressure of no more than about 75 bar, specifically at a pressure of no more than about 50 bar to produce a CO₂ and/or N₂ gas. Even more specifically, the reaction occurs at a pressure of no more than about 25 bar, or even no more than about 15 bar, or not more than about 10 bar. Most specifically, the reaction occurs at, or about atmospheric pressure. Depending on the formulation of the catalyst according to the present invention, the present method may be conducted at reactant gas temperatures ranging from less than about 100° C. to up to about 250° C. Space velocities may range from about 1 hr⁻¹ up to about 1,000,000 hr⁻¹, preferably from about 5000 hr⁻¹ to about 200, 000 hr⁻¹, and more preferably from about 10,000 hr⁻¹ to about 100,000 hr⁻¹. Feed ratios, temperature, pressure and the desired product ratio are factors that would normally be considered by one of skill in the art to determine a desired optimum space velocity for a particular catalyst formulation.

### Apparatus

The invention further relates to a reactor system for generation of a CO₂ and/or N₂ gas from a CO containing gas, a VOC containing gas, or a nitrogen oxide containing gas. Such a fuel processing system would comprise, for example, a fuel reformer, a water gas shift reactor and a temperature controller.

The fuel reformer would convert a fuel reactant stream comprising a hydrocarbon or a substituted hydrocarbon fuel to a reformed product stream comprising carbon monoxide, carbon dioxide, hydrogen and water. The fuel reformer may typically have an inlet for receiving the reactant stream, a reaction chamber for converting the reactant stream to the product stream, and an outlet for discharging the product stream.

The fuel processor system would also comprise a water gas shift reactor for effecting a water gas shift reaction at a temperature of less than about 450° C. This water gas shift reactor may comprise an inlet for receiving a water gas shift feed stream comprising carbon monoxide and water from the product stream of the fuel reformer, a reaction chamber having a water gas shift catalyst as described herein located therein, and an outlet for discharging the resulting hydrogen-rich gas. The water gas shift catalyst would preferable be effective for generating hydrogen and carbon dioxide from the water gas shift feed stream.

The temperature controller may be adapted to maintain the temperature of the reaction chamber of the water gas shift reactor at a temperature of less than about 450° C.

A person of skill in the art will understand and appreciate that with respect to each of the preferred catalyst embodiments as described in the preceding paragraphs, the particular components of each embodiment can be present in their elemental state, or in one or more oxide states, or mixtures thereof.

Although the foregoing description is directed to the preferred embodiments of the invention, it is noted that other variations and modifications will be apparent to those skilled in the art, and which may be made without departing from the spirit or scope of the invention.

The following examples illustrate the principles and advantages of the invention.

### EXAMPLES

An 8×1 parallel fixed bed reactor with classical GC analytics was used to test catalysts for CO and VOC oxidation performance. The reactor was used for a combined feed of CO and propylene as a model substance for VOC.

### Catalyst Preparation

For each sample not specifically discussed, approximately 500 mg of each catalyst was prepared by classical incipient wetness impregnation. With this method, the carrier was impregnated with an amount of precursor solution of the active component(s) corresponding to the pore volume of the carrier.

For the determination of the pore volume V_{P}, portions of 50 μL each were added stepwise to 1 g of the carrier material until it just wetted visibly.

The impregnation solution with the volume corresponding to the pore volume of 500 mg carrier was prepared. The compositions of these solutions are shown in the appropriate tables below in the examples for each catalyst.

After the impregnation, the catalysts were dried at ambient temperature for 2 hours and then either impregnated a second or third time or calcined at 300° C. if no second or third impregnation steps were necessary. The calcination ramp is shown in Table 1.

TABLE 1

| temperature [° C.] | duration/rate | |
|---|---|---|
| 25 --> 120 | 0.5 | C./min |
| 120 | 2 | h |
| 120 --> 200 | 1.33 | C./min |
| 200 | 2 | h |
| 200 --> 300 | 2 | C./min |
| 300 | 2 | h |

### Experimental Setup

The reactor used for the reactions consists of 8 parallel fixed bed steel reactor tubes with three independent heaters and K-type thermocouples for each reactor tube, which are controlled by Watlow temperature controllers. The reactor tubes have a length of 19 cm and a heated zone of 8 cm, with an inner diameter of 4 mm. In front of the heated zone the reactor is equipped with two air-operated heat exchangers to make high catalyst bed temperatures possible without damaging any sealing. The catalyst bed is fixed in the middle of the reactor tube between two glass wool plugs. The catalyst bed is a mixture of the respective catalyst and SiC, both with particle sizes ranging between 180 and 425 μm. The dilution is 1:4 catalyst:SiC by volume.

The feeding of the reactor is provided by four mass flow controllers for oxygen, helium, propylene and CO. The feed is split into 8 equal streams by restrictive flow splitters.

The effluents of each reactor flow into a stream selection valve which leads one stream to the GC analytics and the discards the other seven into a fume hood. An analytical device, such as an Agilent Technologies 6890 gas chromatograph was used.

The reactor temperature was set to 75° C. and the gas feed for all four gases was turned on. This condition was held for 110 min. The temperature was raised to 100° C., 125° C., 150° C., 175° C., 200° C. and 225° C. Each temperature was held for 110 min. The reactor was allowed to equilibrate for 40 minutes at each temperature, and the GCs of the last 70 min of each 110 minute temperature period were taken into account. After completion of the 110 min at 225° C., all heating was turned off and the propylene and CO flow was shut down for 60 minutes to let the system cool down to ambient temperature and meanwhile flush the catalyst beds with helium and oxygen.

This procedure was then repeated with a propylene feed and the with a CO feed as described below in Table 2.

After completion of these three runs, the heating and all streams besides helium were turned off. After another 60 minutes, the helium was turned off. Table 2 shows the exact composition of each of the three different feeds. The Argon in the feed is the balance gas for the used CO-bottle, which was a 50:50 mixture of argon and CO. The propylene bottle was 0.5% propylene in helium.

TABLE 2

| | | flow rate | | s.v. |
|---|---|---|---|---|
| run | component | [ml min⁻¹] | vol-% | [h⁻¹] |
| CO + | CO | 3.1 | 1.50% | 24305 |
| propylene | Ar | 3.1 | 1.50% | |
| | propylene | 0.2 | 0.10% | |
| | helium | 160 | 77.67% | |
| | oxygen | 41 | 19.90% | |
| propylene | CO | 0 | 0.00% | 24281 |
| | Ar | 0 | 0.00% | |
| | propylene | 0.2 | 0.10% | |
| | helium | 166 | 80.58% | |
| | oxygen | 41 | 19.90% | |
| CO | CO | 3.1 | 1.50% | 24281 |
| | Ar | 3.1 | 1.50% | |
| | propylene | 0 | 0.00% | |
| | helium | 160 | 77.67% | |
| | oxygen | 41 | 19.90% | |

### Example 1

Activated carbon (Silcarbon SC40) was used as a support. Table 3 shows the catalyst composition data.

TABLE 3

| | 1 | 2 | 3 | 4 | 5 | 6 | 7 |
|---|---|---|---|---|---|---|---|
| carrier | activated carbon, Silcarbon SC40 | | | | | | |
| pore volume [mL/g] | 1.5 | 1.5 | 1.5 | 1.5 | 1.5 | 1.5 | 1.5 |
| weight [mg] | 500 | 500 | 500 | 500 | 500 | 500 | 500 |
| metal 1 | Cobalt | | | | | | |
| precursor | Co(NO₃)₂ | | | | | | |
| conc. [mol/L] | 3.7 | 3.7 | 3.7 | 3.7 | 3.7 | 3.7 | 3.7 |
| volume [μL] | 0 | 125 | 260 | 260 | 260 | 255 | 0 |
| weight [mg] | 0.0 | 27.3 | 56.8 | 56.8 | 56.8 | 55.7 | 0.0 |
| weight-% | 0.0% | 5.2% | 10.2% | 10.2% | 10.2% | 10.0% | 0.0% |
| metal 2 | Ruthenium | | | | | | |
| precursor | Ru(NO)(NO₃)₃ | | | | | | |
| conc. [mol/L] | 0.396 | 0.396 | 0.396 | 0.396 | 0.396 | 0.694 | 0.694 |
| volume [μL] | 125 | 135 | 140 | 0 | 285 | 250 | 0 |
| weight [mg] | 5.0 | 5.4 | 5.6 | 0.0 | 11.4 | 17.5 | 0.0 |
| weight-% | 0.99% | 1.01% | 1.00% | 0.00% | 2.01% | 3.06% | 0.00% |
| water | nanopure, HPLC grade | | | | | | |
| volume [μL] | 625 | 490 | 350 | 490 | 205 | 245 | 750 |

Table 4 summarizes the catalyst composition data and the reaction data for the compositions of Table 3 for CO oxidation in a CO feed as described in Table 2, for propylene combustion in propylene feed as described in Table 2, for CO oxidation in a CO and propylene feed as described in Table 2, and for propylene combustion in a CO and propylene feed as described in Table 2.

TABLE 4

| | catalyst | | | | | | |
|---|---|---|---|---|---|---|---|
| | 1 | 2 | 3 | 4 | 5 | 6 | 7 |
| carrier | SC 40 - activated carbon | | | | | | |
| Ru | 1% | 1% | 1% | 0% | 2% | 3% | 0% |
| Co | 0% | 5% | 10% | 10% | 10% | 10% | 0% |
| Pt | 0% | 0% | 0% | 0% | 0% | 0% | 0% |

Conversion of CO in combined feed

| T [° C.] | X_{CO} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 2 | 0 |
| 125 | 0 | 0 | 0 | 4 | 0 | 4 | 0 |
| 150 | 0 | 0 | 7 | 9 | 7 | 7 | 0 |
| 175 | 3 | 8 | 25 | 18 | 20 | 30 | 0 |
| 200 | 6 | 32 | 95 | 77 | 84 | 100 | 0 |
| 225 | 22 | 100 | 100 | 100 | 100 | 100 | 6 |

Conversion of CO in CO-only feed

| T [° C.] | X_{CO} [%] | | | | | | |
|---|---|---|---|---|---|---|---|
| 75 | 0 | 0 | 0 | 0 | 0 | 0 | 0 |
| 100 | 0 | 0 | 3 | 0 | 15 | 0 | 0 |
| 125 | 2 | 0 | 17 | 10 | 24 | 19 | 0 |
| 150 | 32 | 50 | 100 | 55 | 89 | 100 | 0 |
| 175 | 100 | 100 | 100 | 100 | 100 | 100 | 5 |
| 200 | 100 | 100 | 100 | 100 | 100 | 100 | 8 |
| 225 | 100 | 100 | 100 | 100 | 100 | 100 | 18 |

Conversion of propylene in combined feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 0 |
| 150 | 1 | 0 | 3 | 2 | 3 | 4 | 0 |
| 175 | 2 | 5 | 15 | 5 | 12 | 18 | 0 |
| 200 | 6 | 20 | 58 | 16 | 52 | 78 | 0 |
| 225 | 30 | 73 | 100 | 70 | 100 | 100 | 0 |

Conversion of propylene in propylene-only feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 0 |
| 150 | 0 | 0 | 0 | 0 | 0 | 2 | 0 |
| 175 | 0 | 6 | 10 | 4 | 8 | 13 | 0 |
| 200 | 6 | 21 | 55 | 18 | 48 | 70 | 0 |
| 225 | 25 | 100 | 100 | 78 | 100 | 100 | 2 |

### Example 2

Activated carbon SC40 (Silcarbon SC40) was used as a support. Table 5 shows the catalyst composition data.

TABLE 5

| | 1 | 2 | 3 | 4 | 5 | 6 | 7 |
|---|---|---|---|---|---|---|---|
| carrier | activated carbon, Silcarbon SC40 | | | | | | |
| pore volume [mL/g] | 1.2 | 1.5 | 1.5 | 1.5 | 1.5 | 1.5 | 1.5 |
| weight [mg] | 500 | 500 | 500 | 500 | 500 | 500 | 500 |
| metal 1 | Cobalt | | | | | | |
| precursor | Co(NO₃)₂ | | | | | | |
| conc. [mol/L] | 3.7 | 3.7 | 3.7 | 3.7 | 3.7 | 3.7 | 3.7 |
| volume [μL] | 260 | 125 | 0 | 260 | 260 | 265 | 0 |
| weight [mg] | 56.8 | 27.3 | 0.0 | 56.8 | 56.8 | 57.8 | 0.0 |
| weight-% | 10.1% | 5.1% | 0.0% | 10.1% | 9.9% | 10.0% | 0.0% |
| metal 2 | Ruthenium | | | | | | |
| precursor | Ru(NO)(NO₃)₃ | | | | | | |
| conc. [mol/L] | 0.396 | 0.396 | 0.396 | 0.396 | 0.396 | 0.693 | 0.396 |
| volume [μL] | 125 | 135 | 140 | 0 | 285 | 250 | 0 |
| weight [mg] | 5.0 | 5.4 | 5.6 | 0.0 | 11.4 | 17.5 | 0.0 |
| weight-% | 0.89% | 1.01% | 1.10% | 0.00% | 2.00% | 3.03% | 0.00% |
| metal 3 | Platinum | | | | | | |
| precursor | Pt(NO₃)₃ | | | | | | |
| conc. [mol/L] | 0.346 | 0.346 | 0.346 | 0.346 | 0.346 | 0.346 | 0.346 |
| volume [μL] | 40 | 40 | 40 | 40 | 40 | 40 | 40 |
| weight [mg] | 2.7 | 2.7 | 2.7 | 2.7 | 2.7 | 2.7 | 2.7 |
| weight-% | 0.48% | 0.50% | 0.53% | 0.48% | 0.47% | 0.47% | 0.54% |
| water | nanopure, HPLC grade | | | | | | |
| volume [μL] | 300 | 585 | 710 | 450 | 450 | 445 | 710 |

Table 6 summarizes the catalyst composition data and the reaction data for the compositions of Table 3 for CO oxidation in a CO feed as described in Table 2, for propylene combustion in propylene feed as described in Table 2, for CO oxidation in a CO and propylene feed as described in Table 2, and for propylene combustion in a CO and propylene feed as described in Table 2.

TABLE 6

| | catalyst | | | | | | |
|---|---|---|---|---|---|---|---|
| | 1 | 2 | 3 | 4 | 5 | 6 | 7 |
| carrier | SC 40 - activated carbon | | | | | | |
| Ru | 1% | 1% | 1% | 0% | 2% | 3% | 0% |
| Co | 0% | 5% | 10% | 10% | 10% | 10% | 0% |
| Pt | 0.5% | 0.5% | 0.5% | 0.5% | 0.5% | 0.5% | 0% |

Conversion of CO in combined feed

| T [° C.] | X_{CO} [%] | | | | | | |
|---|---|---|---|---|---|---|---|
| 75 | 0 | 0 | 0 | 0 | 0 | 0 | 0 |
| 100 | 7 | 5 | 0 | 0 | 0 | 4 | 0 |
| 125 | 9 | 12 | 3 | 35 | 5 | 7 | 0 |
| 150 | 30 | 17 | 18 | 59 | 11 | 16 | 0 |
| 175 | 100 | 93 | 100 | 100 | 52 | 74 | 0 |
| 200 | 100 | 100 | 100 | 100 | 100 | 100 | 3 |
| 225 | 100 | 100 | 100 | 100 | 100 | 100 | 7 |

Conversion of CO in CO-only feed

| T [° C.] | X_{CO} [%] | | | | | | |
|---|---|---|---|---|---|---|---|
| 75 | 0 | 0 | 0 | 0 | 0 | 0 | 0 |
| 100 | 0 | 0 | 3 | 0 | 15 | 0 | 0 |
| 125 | 2 | 0 | 17 | 10 | 24 | 19 | 0 |
| 150 | 32 | 50 | 100 | 55 | 89 | 100 | 0 |
| 175 | 100 | 100 | 100 | 100 | 100 | 100 | 5 |
| 200 | 100 | 100 | 100 | 100 | 100 | 100 | 8 |
| 225 | 100 | 100 | 100 | 100 | 100 | 100 | 18 |

Conversion of propylene in combined feed

| T [° C.] | X_{propylene} [%] | | | | | | |
|---|---|---|---|---|---|---|---|
| 75 | 0 | 0 | 0 | 0 | 0 | 0 | 0 |
| 100 | 3 | 0 | 0 | 0 | 0 | 3 | 0 |
| 125 | 6 | 0 | 0 | 5 | 4 | 5 | 0 |
| 150 | 12 | 8 | 7 | 10 | 9 | 12 | 0 |
| 175 | 100 | 22 | 100 | 100 | 23 | 35 | 0 |
| 200 | 100 | 100 | 100 | 100 | 100 | 100 | 2 |
| 225 | 100 | 100 | 100 | 100 | 100 | 100 | 4 |

Conversion of propylene in propylene-only feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 2 | 0 | 0 | 2 | 0 | 2 | 0 |
| 150 | 8 | 8 | 50 | 26 | 100 | 100 | 0 |
| 175 | 100 | 100 | 100 | 100 | 100 | 100 | 0 |
| 200 | 100 | 100 | 100 | 100 | 100 | 100 | 0 |
| 225 | 100 | 100 | 100 | 100 | 100 | 100 | 0 |

### Example 3

SiO₂ (Degussa Aerolyst 350) was used as a support. Table 7 shows the catalyst composition data, which involved 2 impregnation steps.

TABLE 7

| | 1 | 2 | 3 | 4 | 5 | 6 | 7 |
|---|---|---|---|---|---|---|---|
| carrier | Degussa Aerolyst 350 | | | | | | |
| pore volume [mL/g] | 0.9 | 0.9 | 0.9 | 0.9 | 0.9 | 0.9 | 0.9 |
| weight [mg] | 500 | 500 | 500 | 500 | 500 | 500 | 500 |
| metal 1 | Cobalt, 1st impregnation step | | | | | | |
| precursor | Co(NO₃)₂ | | | | | | |
| conc. [mol/L] | 3.7 | 3.7 | 3.7 | 3.7 | 3.7 | 3.7 | 3.7 |
| volume [μL] | 260 | 260 | 260 | 260 | 260 | 260 | |
| weight [mg] | 56.8 | 56.8 | 56.8 | 56.8 | 56.8 | 56.8 | 0.0 |
| weight-% | 10.2% | 10.2% | 10.2% | 10.2% | 10.2% | 10.2% | 0.0% |
| metal 2 | Ruthenium, 1st impregnation step | | | | | | |
| precursor | Ru(NO)(NO₃)₃ | | | | | | |
| conc. [mol/L] | 0.694 | 0.694 | 0.694 | 0.694 | 0.694 | 0.694 | 0.694 |
| volume [μL] | 80 | 80 | 80 | 160 | 160 | 160 | 0 |
| weight [mg] | 5.6 | 5.6 | 5.6 | 11.2 | 11.2 | 11.2 | 0.0 |
| weight-% | 1.00% | 1.00% | 1.00% | 1.97% | 1.97% | 1.97% | 0.00% |
| metal 3 | Zirconium, 2nd impregnation step | | | | | | |
| precursor | (NH₄)₂ZrO(CO₃)₂ | | | | | | |
| conc. [mol/L] | 2.17 | 2.17 | 2.17 | 2.17 | 2.17 | 2.17 | 2.17 |
| volume [μL] | 0 | 50 | 100 | 0 | 50 | 100 | 0 |
| weight [mg] | 0.0 | 9.9 | 19.8 | 0.0 | 9.9 | 19.8 | 0.0 |
| weight-% | 0.00% | 1.73% | 3.40% | 0.00% | 1.71% | 3.37% | 0.00% |
| water | nanopure, HPLC grade | | | | | | |
| volume [μL] 1st imp | 110 | 110 | 110 | 30 | 30 | 30 | 450 |
| volume [μL] 2nd imp | 450 | 400 | 350 | 450 | 400 | 350 | 450 |

Table 8 summarizes the catalyst composition data and the reaction data for the compositions of Table 3 for CO oxidation in a CO feed as described in Table 2, for propylene combustion in propylene feed as described in Table 2, for CO oxidation in a CO and propylene feed as described in Table 2, and for propylene combustion in a CO and propylene feed as described in Table 2.

TABLE 8

| | catalyst | | | | | | |
|---|---|---|---|---|---|---|---|
| | 1 | 2 | 3 | 4 | 5 | 6 | 7 |
| carrier | Degussa Aerolyst 350 - SiO₂ | | | | | | |
| Ru | 1% | 1% | 1% | 2% | 2% | 2% | 0% |
| Co | 10% | 10% | 10% | 10% | 10% | 10% | 0% |
| Zr | 0% | 3.5% | 7% | 0% | 3.5% | 7% | 0% |
| Pt | 0% | 0% | 0% | 0% | 0% | 0% | 0% |

Conversion of CO in combined feed

| T [° C.] | X_{CO} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 0 |
| 150 | 5 | 0 | 0 | 5 | 0 | 0 | 0 |
| 175 | 32 | 6 | 7 | 31 | 7 | 8 | 0 |
| 200 | 81 | 25 | 29 | 100 | 31 | 56 | 0 |
| 225 | 100 | 95 | 100 | 100 | 100 | 100 | 3 |

Conversion of CO in CO-only feed

| T [° C.] | X_{CO} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 18 | 3 | 0 | 65 | 5 | 19 | 0 |
| 150 | 100 | 21 | 31 | 100 | 100 | 100 | 0 |
| 175 | 100 | 100 | 100 | 100 | 100 | 100 | 0 |
| 200 | 100 | 100 | 100 | 100 | 100 | 100 | 0 |
| 225 | 100 | 100 | 100 | 100 | 100 | 100 | 3 |

Conversion of propylene in combined feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 0 |
| 150 | 0 | 0 | 0 | 0 | 0 | 0 | 0 |
| 175 | 16 | 4 | 4 | 16 | 5 | 0 | 0 |
| 200 | 39 | 15 | 16 | 80 | 19 | 39 | 0 |
| 225 | 100 | 61 | 65 | 100 | 93 | 100 | 0 |

Conversion of propylene in propylene-only feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 0 |
| 150 | 0 | 0 | 0 | 0 | 0 | 0 | 0 |
| 175 | 6 | 3 | 0 | 16 | 4 | 7 | 0 |
| 200 | 42 | 16 | 17 | 90 | 23 | 48 | 0 |
| 225 | 100 | 72 | 73 | 100 | 100 | 100 | 0 |

### Example 4

SiO₂ (Degussa Aerolyst 350) was used as a support. Table 9 shows the catalyst composition data, which shows three impregnation steps.

TABLE 9

| | 1 | 2 | 3 | 4 | 5 | 6 | 7 |
|---|---|---|---|---|---|---|---|
| carrier | Degussa Aerolyst 350 | | | | | | |
| pore volume [mL/g] | 0.9 | 0.9 | 0.9 | 0.9 | 0.9 | 0.9 | 0.9 |
| weight [mg] | 500 | 500 | 500 | 500 | 500 | 500 | 500 |
| metal 1 | Cobalt, 1st impregnation step | | | | | | |
| precursor | Co(NO₃)₂ | | | | | | |
| conc. [mol/L] | 3.7 | 3.7 | 3.7 | 3.7 | 3.7 | 3.7 | 3.7 |
| volume [μL] | 260 | 260 | 260 | 260 | 260 | 260 | |
| weight [mg] | 56.8 | 56.8 | 56.8 | 56.8 | 56.8 | 56.8 | 0.0 |
| weight-% | 10.2% | 10.0% | 9.8% | 10.2% | 10.0% | 9.8% | 0.0% |
| metal 2 | Ruthenium, 1st impregnation step | | | | | | |
| precursor | Ru(NO)(NO₃)₃ | | | | | | |
| conc. [mol/L] | 0.694 | 0.694 | 0.694 | 0.694 | 0.694 | 0.694 | 0.694 |
| volume [μL] | 80 | 80 | 85 | 160 | 165 | 170 | 0 |
| weight [mg] | 5.6 | 5.6 | 6.0 | 11.2 | 11.6 | 11.9 | 0.0 |
| weight-% | 0.99% | 0.98% | 1.02% | 1.97% | 2.00% | 2.02% | 0.00% |
| metal 3 | Zirconium, 2nd impregnation step | | | | | | |
| precursor | (NH₄)₂ZrO(CO₃)₂ | | | | | | |
| conc. [mol/L] | 2.17 | 2.17 | 2.17 | 2.17 | 2.17 | 2.17 | 2.17 |
| volume [μL] | 0 | 50 | 100 | 0 | 50 | 100 | 0 |
| weight [mg] | 0.0 | 9.9 | 19.8 | 0.0 | 9.9 | 19.8 | 0.0 |
| weight-% | 0.00% | 1.73% | 3.39% | 0.00% | 1.71% | 3.36% | 0.00% |
| metal 4 | Platinum, 3nd impregnation step | | | | | | |
| precursor | (NH₄)₂Pt(NO₂)₂ | | | | | | |
| conc. [mol/L] | 0.347 | 0.347 | 0.347 | 0.347 | 0.347 | 0.347 | 0.347 |
| volume [μL] | 40 | 40 | 40 | 40 | 40 | 40 | 0 |
| weight [mg] | 1.3 | 1.3 | 1.3 | 1.3 | 1.3 | 1.3 | 0.0 |
| weight-% | 0.00% | 1.73% | 3.39% | 0.00% | 1.71% | 3.36% | 0.00% |
| water | nanopure, HPLC grade | | | | | | |
| volume [μL] 1st imp | 110 | 110 | 110 | 30 | 30 | 30 | 450 |
| volume [μL] 2nd imp | 450 | 400 | 350 | 450 | 400 | 350 | 450 |
| volume [μL] 3nd imp | 410 | 410 | 410 | 410 | 410 | 410 | 450 |

Table 10 summarizes the catalyst composition data and the reaction data for the compositions of Table 3 for CO oxidation in a CO feed as described in Table 2, for propylene combustion in propylene feed as described in Table 2, for CO oxidation in a CO and propylene feed as described in Table 2, and for propylene combustion in a CO and propylene feed as described in Table 2.

TABLE 10

| | catalyst | | | | | | |
|---|---|---|---|---|---|---|---|
| | 1 | 2 | 3 | 4 | 5 | 6 | 7 |
| carrier | Degussa Aerolyst 350 - SiO₂ | | | | | | |
| Ru | 1% | 1% | 1% | 2% | 2% | 2% | 0% |
| Co | 10% | 10% | 10% | 10% | 10% | 10% | 0% |
| Zr | 0% | 3.5% | 7% | 0% | 3.5% | 7% | 0% |
| Pt | 0.5% | 0.5% | 0.5% | 0.5% | 0.5% | 0.5% | 0.5% |

Conversion of CO in combined feed

| T [° C.] | X_{CO} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 0 |
| 150 | 5 | 0 | 0 | 5 | 0 | 0 | 0 |
| 175 | 32 | 6 | 7 | 28 | 5 | 11 | 0 |
| 200 | 81 | 25 | 29 | 100 | 30 | 56 | 2 |
| 225 | 100 | 95 | 100 | 100 | 100 | 100 | 3 |

Conversion of CO in CO-only feed

| T [° C.] | X_{CO} [%] | | | | | | |
|---|---|---|---|---|---|---|---|
| 75 | 0 | 0 | 0 | 0 | 0 | 0 | 0 |
| 100 | 7 | 0 | 0 | 12 | 2 | 2 | 0 |
| 125 | 100 | 3 | 4 | 63 | 5 | 17 | 0 |
| 150 | 100 | 21 | 28 | 100 | 100 | 100 | 0 |
| 175 | 100 | 100 | 100 | 100 | 100 | 100 | 0 |
| 200 | 100 | 100 | 100 | 100 | 100 | 100 | 2 |
| 225 | 100 | 100 | 100 | 100 | 100 | 100 | 3 |

Conversion of propylene in combined feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 0 |
| 150 | 0 | 0 | 0 | 3 | 0 | 0 | 0 |
| 175 | 9 | 4 | 4 | 15 | 5 | 7 | 0 |
| 200 | 39 | 15 | 14 | 77 | 19 | 48 | 0 |
| 225 | 100 | 61 | 60 | 100 | 93 | 100 | 0 |

Conversion of propylene in propylene-only feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 0 |
| 150 | 0 | 0 | 0 | 4 | 0 | 0 | 0 |
| 175 | 9 | 4 | 3 | 16 | 3 | 7 | 0 |
| 200 | 42 | 15 | 17 | 90 | 23 | 48 | 1 |
| 225 | 100 | 61 | 90 | 100 | 100 | 100 | 2 |

### Example 5

The support for the catalysts of this example was made by adding 120 mL of a 1 M aqueous solution of NMe₄OH and 270 ml of an aqueous solution of NMe₄OH (0.44 M) and Ce(NO₃)₄ (0.11 M) (pH 0.98) drop wise to 200 mL of nanopure water stirred at 60° C. The dropping speed was adjusted to maintain a pH of 7-7.5. The mixture was stirred for 2 hours at 60° C. and at 80° C. over night. The precipitate was washed and centrifuged two times with water and the dried and calcined according to the temperature ramp shown in Table 11. The composition had a BET surface area of 188 m²/g.

TABLE 11

| temperature [° C.] | duration/rate | |
|---|---|---|
| 25 --> 110 | 1° | C./min |
| 110 | 10 | h |
| 110 --> 300 | 5° | C./min |
| 300 | 2 | h |

CeO₂, made as discussed above, was used as a support. Table 12 shows the catalyst composition data, which shows three impregnation steps.

TABLE 12

| | 1 | 2 | 3 | 4 | 5 | 6 | 7 |
|---|---|---|---|---|---|---|---|
| carrier | CeO₂, NMe₄OH method, 188 m²g⁻¹ | | | | | | |
| pore volume [mL/g] | 0.33 | 0.33 | 0.33 | 0.33 | 0.33 | 0.33 | 0.33 |
| weight [mg] | 500 | 500 | 500 | 500 | 500 | 500 | 500 |
| metal 1 | Cobalt, 1st impregnation step | | | | | | |
| precursor | Co(NO₃)₂ | | | | | | |
| conc. [mol/L] | 6 | 6 | 6 | 6 | 6 | 6 | 6 |
| volume [μL] | 165 | 165 | 165 | 165 | 165 | 165 | 0 |
| weight [mg] | 58.4 | 58.4 | 58.4 | 58.4 | 58.4 | 58.4 | 0.0 |
| weight-% | 10.5% | 10.5% | 10.5% | 10.4% | 10.4% | 10.4% | 0.0% |
| metal 2 | Ruthenium, 2nd impregnation step | | | | | | |
| precursor | Ru(NO)(NO₃)₃ | | | | | | |
| conc. [mol/L] | 0.694 | 0.694 | 0.694 | 0.694 | 0.694 | 0.694 | 0.694 |
| volume [μL] | 0 | 80 | 160 | 0 | 80 | 165 | 0 |
| weight [mg] | 0.0 | 5.6 | 11.2 | 0.0 | 5.6 | 11.6 | 0.0 |
| weight-% | 0.00% | 0.99% | 1.97% | 0.00% | 0.99% | 2.02% | 0.00% |
| metal 3 | Platinum, 3st impregnation step | | | | | | |
| precursor | (NH₄)₂Pt(NO₂)₂ | | | | | | |
| conc. [mol/L] | 0.1024 | 0.1024 | 0.1024 | 0.1024 | 0.1024 | 0.1024 | 0.1024 |
| volume [μL] | 0 | 0 | 0 | 150 | 150 | 150 | 0 |
| weight [mg] | 0.0 | 0.0 | 0.0 | 3.0 | 3.0 | 3.0 | 0.0 |
| weight-% | 0.00% | 0.00% | 0.00% | 0.53% | 0.53% | 0.52% | 0.00% |
| water | nanopure, HPLC grade | | | | | | |
| volume [μL] 1st imp | 0 | 0 | 0 | 0 | 0 | 0 | 165 |
| volume [μL] 2nd imp | 165 | 85 | 5 | 165 | 85 | 0 | 165 |
| volume [μL] 3nd imp | 165 | 165 | 165 | 15 | 15 | 15 | 165 |

Table 13 summarizes the catalyst composition data and the reaction data for the compositions of Table 3 for CO oxidation in a CO feed as described in Table 2, for propylene combustion in propylene feed as described in Table 2, for CO oxidation in a CO and propylene feed as described in Table 2, and for propylene combustion in a CO and propylene feed as described in Table 2.

TABLE 13

| | catalyst | | | | | | |
|---|---|---|---|---|---|---|---|
| | 1 | 2 | 3 | 4 | 5 | 6 | 7 |
| carrier | CeO₂ - C300 188 m²g⁻¹ | | | | | | |
| Ru | 0% | 1% | 2% | 0% | 1% | 2% | 0% |
| Co | 10% | 10% | 10% | 10% | 10% | 10% | 0% |
| Pt | 0% | 0% | 0% | 0.5% | 0.5% | 0.5% | 0% |

Conversion of CO in combined feed

| T [° C.] | X_{CO} [%] | | | | | | |
|---|---|---|---|---|---|---|---|
| 75 | 4 | 23 | 55 | 0 | 41 | 49 | 0 |
| 100 | 6 | 35 | 100 | 41 | 59 | 74 | 0 |
| 125 | 11 | 83 | 100 | 78 | 100 | 100 | 0 |
| 150 | 18 | 100 | 100 | 100 | 100 | 100 | 0 |
| 175 | 51 | 100 | 100 | 100 | 100 | 100 | 0 |
| 200 | 81 | 100 | 100 | 100 | 100 | 100 | 5 |
| 225 | 100 | 100 | 100 | 100 | 100 | 100 | 10 |

Conversion of CO in CO-only feed

| T [° C.] | X_{CO} [%] | | | | | | |
|---|---|---|---|---|---|---|---|
| 75 | 0 | 0 | 0 | 0 | 0 | 0 | 0 |
| 100 | 0 | 0 | 0 | 3 | 0 | 0 | 0 |
| 125 | 0 | 0 | 8 | 10 | 9 | 13 | 0 |
| 150 | 0 | 21 | 29 | 27 | 27 | 43 | 0 |
| 175 | 10 | 76 | 88 | 90 | 87 | 100 | 0 |
| 200 | 40 | 100 | 100 | 100 | 100 | 100 | 5 |
| 225 | 77 | 100 | 100 | 100 | 100 | 100 | 10 |

Conversion of propylene in combined feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 4 | 0 | 0 | 5 | 0 |
| 150 | 0 | 0 | 12 | 5 | 8 | 16 | 0 |
| 175 | 0 | 32 | 40 | 12 | 35 | 48 | 0 |
| 200 | 4 | 86 | 100 | 45 | 100 | 100 | 0 |
| 225 | 13 | 100 | 100 | 100 | 100 | 100 | 0 |

Conversion of propylene in propylene-only feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 5 | 0 |
| 150 | 0 | 9 | 14 | 0 | 12 | 24 | 0 |
| 175 | 0 | 40 | 50 | 11 | 49 | 70 | 0 |
| 200 | 0 | 100 | 100 | 57 | 100 | 100 | 0 |
| 225 | 13 | 100 | 100 | 100 | 100 | 100 | 1 |

### Example 6

The catalysts in this example were on a SnO₂ support. The support was made by adding 150 mL of a 0.6 M solution of SnCl₄.5 H₂O drop wise to 100 g of a 34% aqueous hydrazine solution at ambient temperature while stirring. A white precipitate formed immediately. After complete addition, the mixture was refluxed for 10 days. The precipitate was washed and centrifuged with H₂O until no more chloride could be detected in the residual water. The product was then dried for 16 hours in air at 120° C. The dried product was calcined at 300° C. for 2 hours in air. The material was found to have a BET surface area of 249 m²/g.

SnO₂, made as discussed above, was used as a support. Table 14 shows the catalyst composition data, which shows two impregnation steps.

TABLE 14

| | 1 | 2 | 3 | 4 | 5 | 6 | 7 |
|---|---|---|---|---|---|---|---|
| carrier | SnO₂, hydrazine method, C300 234 m²g⁻¹ | | | | | | |
| pore volume [mL/g] | 0.75 | 0.75 | 0.75 | 0.75 | 0.75 | 0.75 | 0.75 |
| weight [mg] | 500 | 500 | 500 | 500 | 500 | 500 | 500 |
| metal 1 | Cobalt, 1st impregnation step | | | | | | |
| precursor | Co(NO₃)₂ | | | | | | |
| conc. [mol/L] | 3.7 | 3.7 | 3.7 | 3.7 | 3.7 | 3.7 | 3.7 |
| volume [μL] | 260 | 260 | 260 | 260 | 260 | 260 | 0 |
| weight [mg] | 56.8 | 56.8 | 56.8 | 56.8 | 56.8 | 56.8 | 0.0 |
| weight-% | 10.2% | 10.2% | 10.2% | 10.1% | 10.1% | 10.1% | 0.0% |
| metal 2 | Ruthenium, 1st impregnation step | | | | | | |
| precursor | Ru(NO)(NO₃)₃ | | | | | | |
| conc. [mol/L] | 0.694 | 0.694 | 0.694 | 0.694 | 0.694 | 0.694 | 0.694 |
| volume [μL] | 0 | 80 | 160 | 0 | 80 | 165 | 0 |
| weight [mg] | 0.0 | 5.6 | 11.2 | 0.0 | 5.6 | 11.6 | 0.0 |
| weight-% | 0.00% | 1.00% | 1.97% | 0.00% | 0.99% | 2.02% | 0.00% |
| metal 3 | Platinum, 2nd impregnation step | | | | | | |
| precursor | (NH₄)₂Pt(NO₂)₂ | | | | | | |
| conc. [mol/L] | 0.1024 | 0.1024 | 0.1024 | 0.1024 | 0.1024 | 0.1024 | 0.1024 |
| volume [μL] | 0 | 0 | 0 | 150 | 150 | 150 | 0 |
| weight [mg] | 0.0 | 0.0 | 0.0 | 3.0 | 3.0 | 3.0 | 0.0 |
| weight-% | 0.00% | 0.00% | 0.00% | 0.54% | 0.53% | 0.52% | 0.00% |
| water | nanopure, HPLC grade | | | | | | |
| volume [μL] 1st imp | 115 | 35 | 0 | 115 | 35 | 0 | 165 |
| volume [μL] 2nd imp | 375 | 375 | 375 | 225 | 225 | 225 | 165 |

Table 15 summarizes the catalyst composition data and the reaction data for the compositions of Table 3 for CO oxidation in a CO feed as described in Table 2, for propylene combustion in propylene feed as described in Table 2, for CO oxidation in a CO and propylene feed as described in Table 2, and for propylene combustion in a CO and propylene feed as described in Table 2.

TABLE 15

| | catalyst | | | | | | |
|---|---|---|---|---|---|---|---|
| | 1 | 2 | 3 | 4 | 5 | 6 | 7 |
| carrier | SiO₂-hydrazine method C300 234 m²g⁻¹ | | | | | | |
| Ru | 0% | 1% | 2% | 0% | 1% | 2% | 0% |
| Co | 10% | 10% | 10% | 10% | 10% | 10% | 0% |
| Pt | 0% | 0% | 0% | 0.5% | 0.5% | 0.5% | 0% |

Conversion of CO in combined feed

| T [° C.] | X_{CO} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 0 |
| 150 | 0 | 0 | 5 | 0 | 0 | 2 | 0 |
| 175 | 7 | 7 | 14 | 6 | 5 | 8 | 0 |
| 200 | 13 | 17 | 32 | 19 | 15 | 28 | 0 |
| 225 | 44 | 44 | 96 | 61 | 52 | 90 | 0 |

Conversion of CO in CO-only feed

| T [° C.] | X_{CO} [%] | | | | | | |
|---|---|---|---|---|---|---|---|
| 75 | 0 | 0 | 0 | 0 | 0 | 0 | 0 |
| 100 | 2 | 0 | 0 | 0 | 0 | 0 | 0 |
| 125 | 2 | 0 | 5 | 6 | 0 | 26 | 0 |
| 150 | 3 | 4 | 39 | 14 | 9 | 40 | 0 |
| 175 | 57 | 23 | 100 | 46 | 34 | 100 | 0 |
| 200 | 100 | 100 | 100 | 100 | 100 | 100 | 0 |
| 225 | 100 | 100 | 100 | 100 | 100 | 100 | 0 |

Conversion of propylene in combined feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 1 | 0 | 1 | 0 | 0 | 0 |
| 125 | 1 | 1 | 1 | 1 | 2 | 1 | 0 |
| 150 | 3 | 2 | 3 | 2 | 2 | 2 | 0 |
| 175 | 7 | 5 | 9 | 7 | 6 | 9 | 0 |
| 200 | 13 | 11 | 24 | 12 | 12 | 22 | 0 |
| 225 | 44 | 27 | 90 | 22 | 24 | 68 | 0 |

Conversion of propylene in propylene-only feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 0 |
| 150 | 0 | 0 | 0 | 0 | 0 | 0 | 0 |
| 175 | 0 | 0 | 0 | 0 | 0 | 4 | 0 |
| 200 | 6 | 7 | 22 | 28 | 100 | 25 | 0 |
| 225 | 21 | 28 | 100 | 100 | 100 | 100 | 0 |

### Example 7

The catalysts in this example were on mixed metal oxide supports of varying surface area.

The carrier for catalysts 1 and 2 in Table 17, were made by dissolving 88.5 mg Sn(OAc)₄ in 5 ml 50% aqueous glyoxylic acid. 1 mL 1 M Ce(NO₃)₃ and 1.5 mL 1 M Co-II-acetate were then added to the mixture. After calcination according to Table 16, a black fluffy powder was obtained. The calculated composition was Ce_{0.2}Sn_{0.5}Co_{0.3}Oₓ. The carrier had a BET surface area of 125 m²/g.

The carrier for catalysts 3 and 4 in Table 17, were made by dissolving 36 mg Sn(OAc)₄ in 5 ml 50% aqueous glyoxylic acid. 2 mL 1 M Ce(NO₃)₃ and 2 mL 1 M Co-II-acetate were then added to the mixture. After calcination according to Table 16, a black fluffy powder was obtained. The calculated composition was Ce_{0.4}Sn_{0.2}CO_{0.4}Oₓ. The carrier had a BET surface area of 95 m²g⁻¹.

The carrier for catalysts 5 and 6 in Table 17, were made by dissolving 44 mg Sn(OAc)₄ in 5 ml 50% aqueous glyoxylic acid. 1.25 mL 1 M Ce(NO₃)₃ and 2.5 mL 1 M Co-II-acetate were then added to the mixture. After calcination according to Table 16, a black fluffy powder was obtained. The calculated composition was Ce_{0.25}Sn_{0.25}Co_{0.5}Oₓ. The carrier had a BET surface area of 137 m²g⁻¹.

Catalyst 7 is the undoped carrier from column 1 and 2.

TABLE 16

| temperature [° C.] | duration/rate | |
|---|---|---|
| 25 --> 120 | 0.5° | C./min |
| 120 | 2 | h |
| 120 --> 200 | 1.33° | C./min |
| 200 | 2 | h |
| 200 --> 325 | 2° | C./min |
| 325 | 3 | h |

Mixed metal oxides having Ce, Co and Sn, made as discussed above, were used as supports. Table 17 shows the catalyst composition data, which shows two impregnation steps.

TABLE 17

| | 1 | 2 | 3 | 4 | 5 | 6 | 7 |
|---|---|---|---|---|---|---|---|
| carrier | Ce_{0.2}Sn_{0.5}Co_{0.3}Oₓ | | Ce_{0.4}Sn_{0.2}Co_{0.4}Oₓ | | Ce_{0.25}Sn_{0.25}Co_{0.5}Oₓ | | Ce_{0.2}Sn_{0.5}Co_{0.3}Oₓ |
| | 125 m²g⁻¹ | | 95 m²g⁻¹ | | 137 m²g⁻¹ | | |
| pore volume [mL/g] | 1 | 1 | 1.15 | 1.15 | 1 | 1 | 1.15 |
| weight [mg] | 500 | 500 | 500 | 500 | 500 | 500 | 500 |
| metal 1 | Ruthenium, 1st impregnation step | | | | | | |
| precursor | Ru(NO)(NO₃)₃ | | | | | | |
| conc. [mol/L] | 0.694 | 0.694 | 0.694 | 0.694 | 0.694 | 0.694 | 0.694 |
| volume [μL] | 75 | 75 | 75 | 75 | 75 | 75 | 0 |
| weight [mg] | 5.3 | 5.3 | 5.3 | 5.3 | 5.3 | 5.3 | 0.0 |
| weight-% | 1.04% | 1.04% | 1.04% | 1.04% | 1.04% | 1.04% | 0.00% |
| metal 2 | Platinum, 2nd impregnation step | | | | | | |
| precursor | (NH₄)₂Pt(NO₂)₂ | | | | | | |
| conc. [mol/L] | 0.1024 | 0.1024 | 0.1024 | 0.1024 | 0.1024 | 0.1024 | 0.1024 |
| volume [μL] | 0 | 130 | 0 | 130 | 0 | 130 | 0 |
| weight [mg] | 0.0 | 2.6 | 0.0 | 2.6 | 0.0 | 2.6 | 0.0 |
| weight-% | 0.00% | 0.51% | 0.00% | 0.51% | 0.00% | 0.51% | 0.00% |
| water | nanopure, HPLC grade | | | | | | |
| volume [μL] 1st imp | 425 | 425 | 425 | 425 | 425 | 425 | 500 |
| volume [μL] 2nd imp | 500 | 370 | 500 | 370 | 500 | 370 | 500 |

Table 18 summarizes the catalyst composition data and the reaction data for the compositions of Table 3 for CO oxidation in a CO feed as described in Table 2, for propylene combustion in propylene feed as described in Table 2, for CO oxidation in a CO and propylene feed as described in Table 2, and for propylene combustion in a CO and propylene feed as described in Table 2.

TABLE 18

| | catalyst | | | | | | |
|---|---|---|---|---|---|---|---|
| | 1 | 2 | 3 | 4 | 5 | 6 | 7 |
| carrier | Ce_{0.2}Sn_{0.5}Co_{0.3}Oₓ | | Ce_{0.2}Sn_{0.5}Co_{0.3}Oₓ | | Ce_{0.2}Sn_{0.5}Co_{0.3}Oₓ | | Ce_{0.2}Sn_{0.5}Co_{0.3}Oₓ |
| | 125 m²g⁻¹ | | 95 m²g⁻¹ | | 137 m²g⁻¹ | | |
| Ru | 1% | 1% | 1% | 1% | 1% | 1% | 0% |
| Co | no additional to the carrier | | | | | | |
| Pt | 0.5% | 0% | 0.5% | 0% | 0.5% | 0% | 0% |

Conversion of CO in combined feed

| T [° C.] | X_{CO} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 2 |
| 125 | 0 | 0 | 0 | 0 | 0 | 0 | 4 |
| 150 | 4 | 5 | 7 | 6 | 6 | 8 | 4 |
| 175 | 15 | 18 | 25 | 26 | 19 | 28 | 8 |
| 200 | 60 | 69 | 100 | 100 | 100 | 100 | 25 |
| 225 | 100 | 100 | 100 | 100 | 100 | 100 | 91 |

Conversion of CO in CO-only feed

| T [° C.] | X_{CO} [%] | | | | | | |
|---|---|---|---|---|---|---|---|
| 75 | 0 | 0 | 0 | 0 | 0 | 0 | 0 |
| 100 | 4 | 3 | 5 | 0 | 0 | 0 | 0 |
| 125 | 12 | 15 | 29 | 28 | 22 | 35 | 10 |
| 150 | 54 | 75 | 100 | 100 | 100 | 100 | 37 |
| 175 | 100 | 100 | 100 | 100 | 100 | 100 | 100 |
| 200 | 100 | 100 | 100 | 100 | 100 | 100 | 100 |
| 225 | 100 | 100 | 100 | 100 | 100 | 100 | 100 |

Conversion of propylene in combined feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 2 |
| 150 | 0 | 1 | 4 | 5 | 2 | 5 | 4 |
| 175 | 9 | 10 | 15 | 16 | 16 | 18 | 6 |
| 200 | 38 | 43 | 100 | 100 | 53 | 100 | 10 |
| 225 | 100 | 100 | 100 | 100 | 100 | 100 | 22 |

Conversion of propylene in propylene-only feed

| T [° C.] | X_{propylene} [%] | | | | | | |
|---|---|---|---|---|---|---|---|
| 75 | 0 | 0 | 0 | 0 | 0 | 0 | 0 |
| 100 | 0 | 0 | 0 | 0 | 0 | 0 | 0 |
| 125 | 0 | 0 | 0 | 0 | 0 | 0 | 0 |
| 150 | 3 | 4 | 6 | 6 | 4 | 5 | 0 |
| 175 | 10 | 14 | 19 | 27 | 12 | 25 | 0 |
| 200 | 55 | 100 | 100 | 100 | 72 | 100 | 5 |
| 225 | 100 | 100 | 100 | 100 | 100 | 100 | 24 |

### Example 8

Each catalyst in this example was made by mixing the precursors listed in Table 19 with 10 mL of 50% glyoxylic acid. The samples were then heated to 120° C. over 4 hours, held at 120° C. for 2 hours, ramped from 120° C.-200° C. over 1 hour, held at 200° C. for 2 hours, ramped from 200° C.-350° C. over 2 hours, and held at 350° C. for 4 hours. The composition data is shown below in Table.

TABLE 19

| | catalyst | | | | | | |
|---|---|---|---|---|---|---|---|
| | 1 | 2 | 3 | 4 | 5 | 6 | 7 |
| Metal 1 | Ru | | | | | | |
| precursor | Ru(NO)(NO3)3 | | | | | | |
| conc. [mol\l] | 0.694 | | | | | | |
| weight-% | 5% | 5% | 5% | 5% | 5% | 5% | 5% |
| volume | 0.712622 | 0.712622 | 0.712622 | 0.712622 | 0.712622 | 0.712622 | 0.712622 |
| [mL] | | | | | | | |
| Metal 2 | Co | | | | | | |
| precursor | Co(NO3)2 | | | | | | |
| conc. [mol\l] | 1 | | | | | | |
| weight-% | 45% | 45% | 45% | 45% | 45% | 45% | 45% |
| volume | 7.640068 | 7.640068 | 7.640068 | 7.640068 | 7.640068 | 7.640068 | 7.640068 |
| [mL] | | | | | | | |
| Metal 3 | Y | | | | | | |
| precursor | Y(NO3)3 | | | | | | |
| conc. [mol\l] | 2 | | | | | | |
| weight-% | 0.0% | 8.3% | 16.7% | 25.0% | 33.3% | 41.7% | 50.0% |
| volume | 0 | 0.468691 | 0.937383 | 1.406074 | 1.874766 | 2.343457 | 2.812148 |
| [mL] | | | | | | | |
| Metal 4 | Ce | | | | | | |
| precursor | Ce(NO3)3 | | | | | | |
| conc. [mol\l] | 1.5 | | | | | | |
| weight-% | 50% | 42% | 33% | 25% | 17% | 8% | 0% |
| volume | 2.379253 | 1.982711 | 1.586169 | 1.189627 | 0.793084 | 0.396542 | 0 |
| [mL] | | | | | | | |

Table 20 summarizes the catalyst composition data and the reaction data for the compositions of Table 3 for CO oxidation in a CO feed as described in Table 2, for propylene combustion in propylene feed as described in Table 2, for CO oxidation in a CO and propylene feed as described in Table 2, and for propylene combustion in a CO and propylene feed as described in Table 2.

TABLE 20

| | catalyst | | | | | | |
|---|---|---|---|---|---|---|---|
| | 1 | 2 | 3 | 4 | 5 | 6 | 7 |
| Ru | 5% | 5% | 5% | 5% | 5% | 5% | 5% |
| Co | 45% | 45% | 45% | 45% | 45% | 45% | 45% |
| Ce | 50% | 41.7% | 33.3% | 25.0% | 16.7% | 8.3% | 0.0% |
| Y | 0% | 8% | 17% | 25% | 33% | 42% | 50% |

Conversion of CO in combined feed

| T [° C.] | X_{CO} [%] | | | | | | |
|---|---|---|---|---|---|---|---|
| 75 | 0 | 0 | 0 | 0 | 0 | 0 | 0 |
| 100 | 26 | 5 | 16 | 6 | 8 | 10 | 5 |
| 125 | 40 | 17 | 33 | 25 | 20 | 23 | 15 |
| 150 | 78 | 45 | 80 | 63 | 50 | 61 | 53 |
| 175 | 100 | 100 | 100 | 100 | 100 | 100 | 74 |
| 200 | 100 | 100 | 100 | 100 | 100 | 100 | 100 |
| 225 | 100 | 100 | 100 | 100 | 100 | 100 | 100 |

Conversion of CO in CO-only feed

| T [° C.] | X_{CO} [%] | | | | | | |
|---|---|---|---|---|---|---|---|
| 75 | 70 | 12 | 100 | 100 | 60 | 100 | 21 |
| 100 | 92 | 23 | 100 | 100 | 100 | 100 | 80 |
| 125 | 100 | 70 | 100 | 100 | 100 | 100 | 100 |
| 150 | 100 | 100 | 100 | 100 | 100 | 100 | 100 |
| 175 | 100 | 100 | 100 | 100 | 100 | 100 | 100 |
| 200 | 100 | 100 | 100 | 100 | 100 | 100 | 100 |
| 225 | 100 | 100 | 100 | 100 | 100 | 100 | 100 |

Conversion of propylene in combined feed

| T [° C.] | X_{propylene} [%] | | | | | | |
|---|---|---|---|---|---|---|---|
| 75 | 0 | 0 | 0 | 0 | 0 | 0 | 0 |
| 100 | 3 | 1 | 2 | 0 | 0 | 0 | 0 |
| 125 | 6 | 2 | 5 | 0 | 0 | 0 | 0 |
| 150 | 12 | 7 | 11 | 12 | 0 | 10 | 4 |
| 175 | 55 | 23 | 35 | 42 | 24 | 33 | 10 |
| 200 | 100 | 100 | 100 | 100 | 100 | 100 | 35 |
| 225 | 100 | 100 | 100 | 100 | 100 | 100 | 100 |

Conversion of propylene in propylene-only feed

| T [° C.] | X_{propylene} [%] | | | | | | |
|---|---|---|---|---|---|---|---|
| 75 | 0 | 0 | 0 | 0 | 0 | 0 | 0 |
| 100 | 1 | 0 | 0 | 0 | 0 | 0 | 0 |
| 125 | 4 | 0 | 0 | 0 | 0 | 0 | 0 |
| 150 | 15 | 5 | 10 | 9 | 0 | 8 | 2 |
| 175 | 67 | 35 | 38 | 42 | 27 | 35 | 8 |
| 200 | 100 | 100 | 100 | 100 | 100 | 100 | 42 |
| 225 | 100 | 100 | 100 | 100 | 100 | 100 | 100 |

In light of the detailed description of the invention and the examples presented above, it can be appreciated that the several objects of the invention are achieved.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention.

1. A method for oxidizing carbon monoxide, the method comprising contacting a carbon monoxide containing gas with a catalyst in the presence of an O₂ containing gas, wherein the catalyst comprises: a) cobalt, its oxides or mixtures thereof, and b) ruthenium, its oxides or mixtures thereof.

2. A method for converting nitrogen oxide, the method comprising contacting a nitrogen oxide containing gas with a catalyst comprising cobalt, its oxides or mixtures thereof and ruthenium, its oxides or mixtures thereof.

3. A method for converting volatile organic compounds, the method comprising contacting a volatile organic compound containing gas with a catalyst in the presence of an O₂ containing gas, wherein the catalyst comprises: a) cobalt, its oxides or mixtures thereof; and b) ruthenium, its oxides or mixtures thereof.

4-13. (canceled)

14. The method of claim 1, wherein the catalyst composition comprises a carrier selected from the group consisting of alumina, zirconia, titania, ceria, magnesia, lanthania, niobia, yttria, silica, iron oxide, cobalt oxide, active carbon, bentonite, zeolite, clay, spinels and mixtures thereof.

15-17. (canceled)

18. The method of claim 1, wherein the catalyst further comprising cerium, its oxides or mixtures thereof, or yttrium, its oxides or mixtures thereof.

19-28. (canceled)

29. The method of claim 1, wherein the catalyst further comprising a noble metal, wherein the ratio of cobalt to noble metal is from about 1000:1 to about 1:1 by weight.

30-35. (canceled)

36. The method of claim 1, wherein the catalyst has an essential absence of platinum, molybdenum, or both platinum and molybdenum.

37. (canceled)

38. The method of claim 1, wherein the catalyst further comprising copper, chromium, manganese, niobium, tin, titanium, silver, zirconium, cerium, iron, nickel, rhenium, rare earth, their oxides or mixtures thereof in an amount of 0.1% to about 10% by weight of the catalyst.

39-54. (canceled)

55. The method of any of claim 2, further comprising contacting the nitrogen oxide containing gas with an O₂ containing gas, ammonia or urea.

56-61. (canceled)

62. A catalyst for use in a reaction selected from the group consisting of (i) carbon monoxide oxidation reactions in the presence of an O₂ containing gas, (ii) nitrogen oxide conversion reactions, (iii) volatile organic compound conversion reactions in the presence of an O₂ containing gas, and (iv) combinations thereof, the catalyst comprising cobalt, its oxides or mixtures thereof and ruthenium, its oxides or mixtures thereof.

63-65. (canceled)

66. The method of claim 2, wherein the catalyst comprises a carrier selected from the group consisting of alumina, zirconia, titania, ceria, magnesia, lanthania, niobia, yttria, silica, iron oxide, cobalt oxide, active carbon, bentonite, zeolite, clay, spinels and mixtures thereof.

67. The method of claim 2, wherein the catalyst further comprising cerium, its oxides or mixtures thereof, or yttrium, its oxides or mixtures thereof.

68. The method of claim 2, wherein the catalyst further comprising a noble metal, wherein the ratio of cobalt to noble metal is from about 1000:1 to about 1:1 by weight.

69. The method of claim 2, wherein the catalyst has an essential absence of platinum, molybdenum, or both platinum and molybdenum.

70. The method of claim 2, wherein the catalyst further comprising copper, chromium, manganese, niobium, tin, titanium, silver, zirconium, cerium, iron, nickel, rhenium, rare earth, their oxides or mixtures thereof in an amount of 0.1% to about 10% by weight of the catalyst.

71. The method of claim 3, wherein the catalyst comprises a carrier selected from the group consisting of alumina, zirconia, titania, ceria, magnesia, lanthania, niobia, yttria, silica, iron oxide, cobalt oxide, active carbon, bentonite, zeolite, clay, spinels and mixtures thereof.

72. The method of claim 3, wherein the catalyst further comprising cerium, its oxides or mixtures thereof, or yttrium, its oxides or mixtures thereof.

73. The method of claim 3, wherein the catalyst further comprising a noble metal, wherein the ratio of cobalt to noble metal is from about 1000:1 to about 1:1 by weight.

74. The method of claim 3, wherein the catalyst has an essential absence of platinum, molybdenum, or both platinum and molybdenum.

75. The method of claim 3, wherein the catalyst further comprising copper, chromium, manganese, niobium, tin, titanium, silver, zirconium, cerium, iron, nickel, rhenium, rare earth, their oxides or mixtures thereof in an amount of 0.1% to about 10% by weight of the catalyst.

76. The catalyst of claim 62, wherein the catalyst comprises a carrier selected from the group consisting of alumina, zirconia, titania, ceria, magnesia, lanthania, niobia, yttria, silica, iron oxide, cobalt oxide, active carbon, bentonite, zeolite, clay, spinels and mixtures thereof.

77. The catalyst of claim 62, wherein the catalyst further comprising cerium, its oxides or mixtures thereof, or yttrium, its oxides or mixtures thereof.

78. The catalyst of claim 62, wherein the catalyst further comprising a noble metal, wherein the ratio of cobalt to noble metal is from about 1000:1 to about 1:1 by weight.

79. The catalyst of claim 62, wherein the catalyst has an essential absence of platinum, molybdenum, or both platinum and molybdenum.

80. The catalyst of claim 62, wherein the catalyst further comprising copper, chromium, manganese, niobium, tin, titanium, silver, zirconium, cerium, iron, nickel, rhenium, rare earth, their oxides or mixtures thereof in an amount of 0.1% to about 10% by weight of the catalyst.
